(19) United States
(12) Patent Application Publication
(10) Pub. No.: US 2003/0050777 A1
(43) Pub. Date: Mar. 13, 2003

(54) System and method for automatic transcription of conversations

(76) Inventor: William Donald Walker JR., Nashua, NH (US)

Correspondence Address: Daniel G. Mackas, McCormick, Paulding & Huber LLP, Cityplace II, 185 Asylum Street, Hartford, CT, 06103-3402, US

(21) Appl. No.: 09/949,337

(22) Filed: Sep. 7, 2001

(51) Int. Cl. G10L 15/26

(52) U.S. Cl. 704/235

(57) ABSTRACT

A system and method for automatically transcribing a conversation of a plurality of persons comprises a plurality of speech recognition engines each dedicated to a particular person involved in the conversation for converting the speech of the particular person into text. A transcription service provides a transcript associated with the conversation based on the texts of the plurality of persons.

### FIELD OF THE INVENTION

This invention relates generally to a voice recognition system, and more particularly to a system which automatically transcribes a conversation among several people.

### BACKGROUND OF THE INVENTION

An automatic speech recognition system according to the present invention identifies random phrases or utterances spoken by a plurality of persons involved in a conversation. The identified random phrases are processed by a plurality of speech recognition engines, each dedicated to and trained to recognize speech for a particular person, in a variety of ways including converting such phrases into dictation results including text. Each recognition engine sends the dictation results to an associated transcription client for generating transcription entries that associate the dictation results with a particular person. The transcription entries of the persons involved in the conversation are sent to a transcription service which stores and retrieves the transcription entries in a predetermined order to generate a transcription of the conversation. The automatic speech recognition system according to the present invention may transcribe a conversation involving several persons speaking simultaneously or nearly simultaneously. Each speech recognition engine, transcription client and transcription service may be physically provided in a centralized location or may be distributed throughout a computer network.

### SUMMARY OF THE INVENTION

In a first aspect of the present invention, a method of automatically transcribing a conversation involving a plurality of persons comprises the steps of: converting words or phrases spoken by several persons into a transcription entry including text based on a plurality of speech recognition engines each dedicated to a particular person involved in the conversation, and transcribing the conversation from the transcription entries.

In a second aspect of the present invention, a system for automatically transcribing a conversation of a plurality of persons comprises a plurality of speech recognition engines each dedicated to a particular person involved in the conversation for converting the speech of the particular person into text. A transcription service provides a transcript associated with the conversation based on the texts of the plurality of persons.

### BRIEF DESCRIPTION OF THE DRAWINGS

FIG. 1 schematically illustrates a system for automatic transcription of conversations in accordance with a first embodiment of the present invention.

FIG. 2 is a flow diagram illustrating a process for transcribing a conversation in accordance with the present invention.

FIG. 3 schematically illustrates a system for automatic transcription of conversations in accordance with a second embodiment of the present invention.

### DETAILED DESCRIPTION OF THE INVENTION

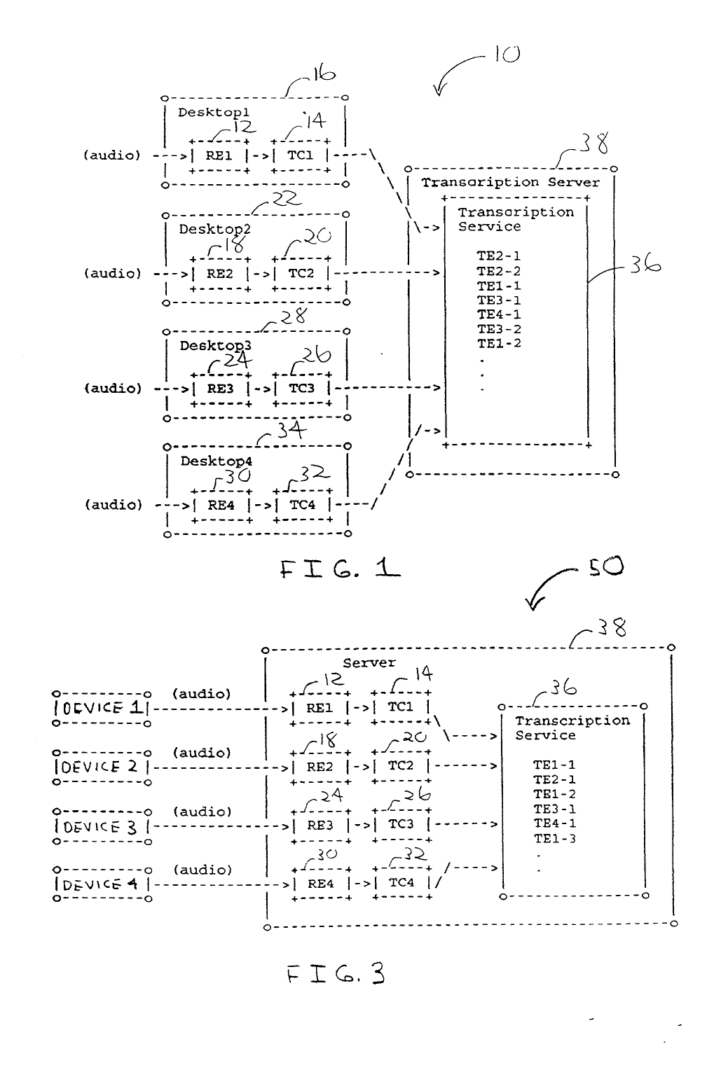

With reference to FIG. 1, a system for automatic transcription of conversations in accordance with a first embodiment of the present invention is generally designated by the reference number 10. The system 10 includes a first speech recognition engine 12 having an input for receiving an audio input signal from, for example, a microphone (not shown), and generating therefrom dictation results such as the text of random phrases or utterances including one or more words spoken by a person during a conversation. The speech recognition engine 12, which is dedicated to and trained by a particular person, provides a dictation result including text for each random phrase spoken by the person. Typical recognition engines that support dictation include IBM ViaVoice and Dragon Dictate. Typical methods for obtaining the dictation results include application programming interfaces such as Microsoft Speech API (SAPI) and the Java Speech API (JSAPI).

A first transcription client 14 associates the dictation results generated by the first speech recognition engine 12 with a particular person. By way of example, the first speech recognition engine 12 and the first transcription client 14 are software applications that reside within the memory of a first personal computer 16, but it should be understood that the first speech recognition engine 12 and the first transcription client 14 may physically reside in alternative ways without departing from the scope of the present invention. For example, the first speech recognition engine 12 and the first transcription client 14 may reside on a server as will be explained more fully with respect to FIG. 3. Alternatively, the first speech recognition engine 12 and the first transcription client 14 may physically reside in separate locations among a computer network.

Additional speech recognition engines and transcription clients may be provided and dedicated to additional persons. For example, the system 10 of FIG. 1 provides for three additional persons. More specifically, a second speech recognition engine 18 and a second transcription client 20 residing in a second personal computer 22 are dedicated to processing phrases spoken by a particular second person. Similarly, a third speech recognition engine 24 and a third transcription client 26 residing in a third personal computer 28 are dedicated to processing phrases spoken by a particular third person. Further, a fourth speech recognition engine 30 and a fourth transcription client 32 residing in a fourth personal computer 34 are dedicated to processing phrases spoken by a particular fourth person. Although the system 10 is shown as handling speech for four persons, it should be understood that the system may be implemented for additional persons without departing from the scope of the present invention.

A transcription service 36 has an input coupled to the outputs of the first through fourth transcription clients 14, 20, 26, 32 for storing transcription entries from the transcription clients and for providing methods of retrieving the transcription entries in a variety of predetermined ways. The methods of retrieving may take into account the time T1 defined as the time each person initiated a transcription entry, and the time T2 defined as the time each person completed a transcription entry. For example, the transcription entries may be arranged or sorted by the time T1 in which each person initiated the transcription entry. This provides an ordered and interleaved transcription of a conversation among several persons. Another way to arrange the transcription entries is by user identification and the time T1 so as to provide an ordered transcription of what one person said during the conversation. Alternatively, the transcription entries may be sorted by matching strings in the text of the transcription entries so as to provide a transcription that encapsulates those portions of the conversation involving a predetermined subject matter.

The transcription service 36 is a software application that resides on a server 38 or device that is physically distinct from the first through fourth personal computers 16, 22, 28, 34, but it should be understood that the transcription service may be physically implemented in alternative ways without departing from the scope of the present invention. For example, the transcription service 36 might reside on one of the first through fourth personal computers 16, 22, 28, 34, or on a dedicated computer communicating with the server 38.

As an example, the transcription service 36 of FIG. 1 schematically shows a plurality of transcription entries retrieved in the order of the time T1 for each entry. The entries are “TE2-1, TE2-2, TE1-1, TE3-1, TE4-1, TE3-2, TE1-2, . . . ” which means that the order of talking among four people during a conversation is: person #2 speaks his/her first phrase; person #2 speaks his/her second phrase; person #1 speaks his/her first phrase; person #3 speaks his/her first phrase; person #4 speaks his/her first phrase; person #3 speaks his/her second phrase; person #1 speaks his/her second phrase, etc. As can be seen, a person may have two or more utterances or spoken phrases with no interleaving results from others. Utterances typically are delineated by a short period of silence, so if a person speaks multiple sentences, there will be multiple utterances stored in the transcription service 36.

As mentioned above, any number of software applications may be employed for the speech recognition engine and the transcription client. For example, each person might have a Microsoft Windows personal computer running IBM's ViaVoice, with each transcription client using the Java Speech API to access the recognition results from ViaVoice. The transcription clients might employ the Java Remote Method Invocation (RMI) to send the transcription entries to the transcription service. Because the first through fourth transcription clients 14, 20, 26, 32 are on separate devices, the transcription clients should synchronize their time with the transcription service 36 in order to guarantee accuracy of the times associated with the transcription entries. This synchronization may be accomplished by using any number of conventional methods.

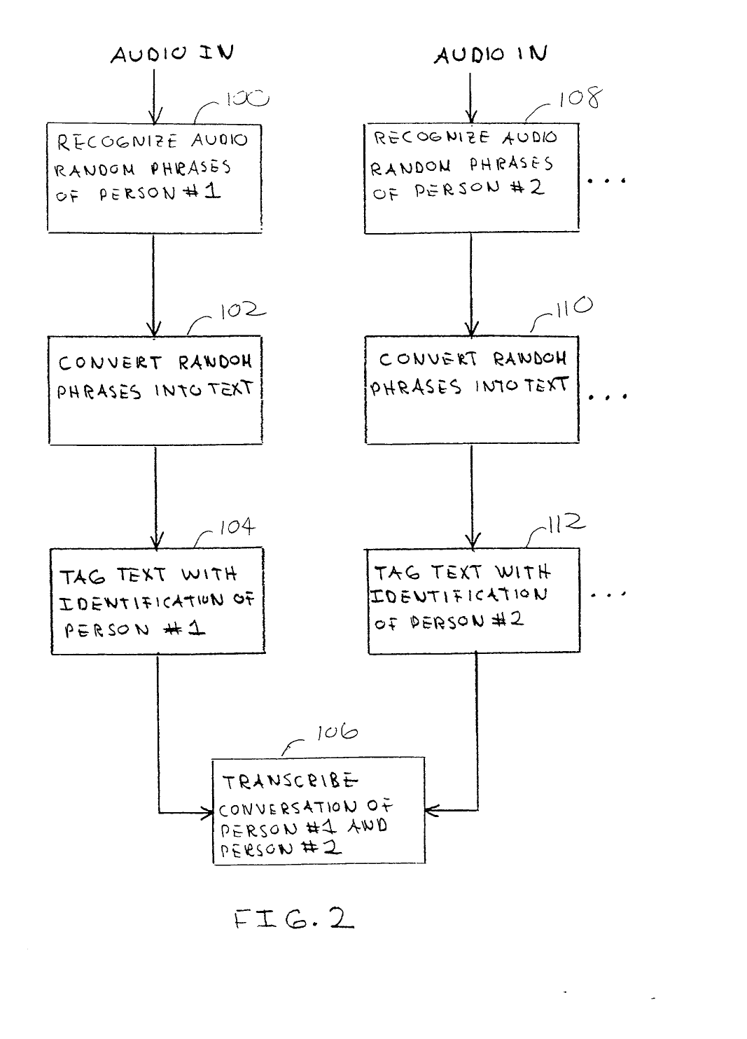

A process for automatically transcribing conversations in accordance with the present invention will now be explained by way of example with respect to the flow diagram of FIG. 2. With regard to the portion of a conversation contributed by a first person, random audio phrases are recognized as coming from person #1 by a speech recognition engine dedicated to person #1 (step 100). The speech recognition engine converts each random phrase or utterance of person #1 into a dictation result including text, and may associate time identification information with each dictation result (step 102). For example, the identification information may include the time T1 the first person started speaking the random phrase, and include the time T2 the first person finished speaking the random phrase. A phrase may be defined as one or a plurality of words spoken during a single exhalation of the person, but it should be understood that a phrase may be defined differently without departing from scope of the present invention. The transcription client tags or otherwise associates each dictation result with the identification of person #1 (step 104). The identified dictation result or transcription entry is stored in the transcription service, and may be retrieved therefrom in a variety of ways as was explained above (step 106).

Simultaneous with the above-described processing of the speech of person #1, the speech of additional persons may be processed. For example, with regard to the portion of a conversation contributed by a second person, random audio phrases are recognized as coming from person #2 by a speech recognition engine dedicated to person #2 (step 108). The speech recognition engine converts each random phrase or utterance of person #2 into a dictation result including text, and may associate time identification information with each dictation result (step 110). The transcription client tags or otherwise associates each dictation result with the identification of person #2 (step 112). The identified dictation result or transcription entry is stored in the transcription service, and the transcription entries among a plurality of persons may be retrieved therefrom in a variety of ways as discussed above to form a transcription of the conversation (step 106).

Turning now to FIG. 3, a system for automatic transcription of conversations in accordance with a second embodiment of the present invention is generally designated by the reference number 50. The system 50 illustrates alternative locations in which the speech recognition engines and transcription clients may reside. As shown in FIG. 3, for example, the first through fourth recognition engines 12, 18, 24, 30 and the first through fourth transcription clients 14, 20, 26, 32 may reside on the server 38 along with the transcription service 36. First through fourth electronic data input devices 40, 42, 44, 46 have inputs such as microphones for respectively receiving audio signals from first through fourth persons involved in a conversation. The first through fourth devices 40, 42, 44, 46 respectively communicate with the first through fourth speech recognition engines 12, 18, 24, 30. As an example, the first through fourth devices 40, 42, 44, 46 may be Sun Ray appliances manufactured and sold by a Sun Microsystems, Inc., and the server may be a Sun Microsystems server that receives information from the Sun Ray appliances. Alternatively, the first through fourth devices 40,42,44,46 may be personal computers or other devices suitable for communicating with a server.

As an example, the transcription service 36 of FIG. 3 shows a plurality of transcription entries retrieved in the order of the time T1 for each entry. The entries are “TE1-1, TE2-1, TE1-2, TE3-1, TE4-1, TE1-3, . . . ” which means that the order of talking during the processed conversation is: person #1 speaks his/her first phrase; person #2 speaks his/her first phrase; person #1 speaks his/her second phrase; person #3 speaks his/her first phrase; person #4 speaks his/her first phrase; person #1 speaks his/her third phrase, etc.

Although the invention has been shown and described above, it should be understood that numerous modifications can be made without departing from the spirit and scope of the present invention. For example, audio signals to be transcribed may be sent to a telephone. A device such as the Andrea Electronics PCTI permits users to simultaneously send audio to a telephone and to their computer. Other means for sending audio to a recognition engine include Voice over IP (VoIP). Accordingly, the present invention has been shown and described in embodiments by way of illustration rather than limitation.

What is claimed is:

1. A method of automatically transcribing a conversation involving a plurality of persons, comprising the steps of:
converting words or phrases spoken by several persons into a transcription entry including text based on a plurality of speech recognition engines each dedicated to a particular person involved in the conversation; and
transcribing the conversation from the transcription entries.

2. A method as defined in claim 1, further including the step of tagging each transcription entry with the time the phrase associated with the transcription entry was initiated.

3. A method as defined in claim 1, further including the step of tagging each transcription entry with the time the phrase associated with the transcription entry was ended.

4. A method as defined in claim 1, further including the step of tagging each transcription entry with the identification of the person associated with the transcription entry.

5. A method as defined in claim 1, further including the step of synchronizing the time to be applied to the transcription entries.

6. A method as defined in claim 1, wherein the step of transcribing includes transcribing each transcription entry in the order of the time each phrase associated with a transcription entry was initiated.

7. A method as defined in claim 1, wherein the step of transcribing includes transcribing each transcription entry in the order of the time each phrase associated with a transcription entry was ended.

8. A method as defined in claim 1, wherein the step of transcribing includes transcribing the transcription entries associated with a predetermined string of text.

9. A method as defined in claim 1, wherein the step of transcribing includes transcribing the transcription entries associated with a predetermined person.

10. A system for automatically transcribing a conversation of a plurality of persons, comprising:
a plurality of speech recognition engines each dedicated to a particular person involved in the conversation for converting the speech of the particular person into text; and
a transcription service for providing a transcript associated with the conversation based on the texts of the plurality of persons.

11. A system as defined in claim 10, further including a plurality of transcription clients each communicating with an associated speech recognition engine for tagging the text generated by the speech recognition engine with the identification of the particular person associated with the text.

12. A system as defined in claim 10, wherein the plurality of the speech recognition engines and the transcription service reside on the same computer.

13. A system as defined in claim 10, wherein the plurality of the speech recognition engines each reside on a distinct computer.

14. A system as defined in claim 10, wherein the plurality of the speech recognition engines and the transcription service each reside on a distinct computer.

15. A system as defined in claim 11, wherein the plurality of speech recognition engines, the plurality of transcription clients and the transcription service reside on the same computer.

16. A system for automatically transcribing a conversation of a plurality of persons, comprising:
a plurality of text-generating means dedicated to a particular person involved in the conversation for converting the speech of the particular person into text;
transcribing means for providing a transcript associated with the conversation based on the texts of the plurality of persons.

17. A system as defined in claim 16, further including a plurality of means each communicating with an associated text-generating means for tagging the text with the identification of the particular person associated with the text.

18. A system as defined in claim 16, wherein the plurality of text-generating means and the transcribing means reside on the same computer.

19. A system as defined in claim 16, wherein the plurality of the text-generating means each reside on a distinct computer.

20. A system as defined in claim 16, wherein the plurality of the text-generating means and the transcribing means each reside on a distinct computer.
